(19) United States
(12) Patent Application Publication
(10) Pub. No.: US 2026/0213498 A1
(43) Pub. Date: Jul. 23, 2026

(54) SPARK PLUG WITH INSERTION AID FOR A LATERALLY INTRODUCED GROUND ELECTRODE

(71) Applicant: Robert Bosch GmbH, Stuttgart (DE)

(72) Inventors: Matthias Blankmeister, Heiligenhaus (DE); Mihail Vinnik, Saratov, Engels (RU); Philipp Rottmann, Bischberg (DE); Stephan Kaske, Sternenfels Diefenbach (DE)

(21) Appl. No.: 19/137,386

(22) PCT Filed: Dec. 11, 2023
(86) PCT No.: PCT/EP2023/085145

§ 371 Date: Jun. 10, 2025

(30) Foreign Application Priority Data
Dec. 20, 2022 (DE) 10 2022 214 076.1

(51) Int. Cl. H01T 13/32; H01T 13/54

(52) U.S. Cl. CPC H01T 13/32; H01T 13/54

(57) ABSTRACT

A spark plug having a longitudinal axis X. The spark plug including: a housing; an insulator arranged within the housing; a center electrode arranged within the insulator; a ground electrode, the ground electrode being rod-shaped and having a radially inner end and a radially outer end; a bore in which the ground electrode is inserted, the bore having a radially outer end and a radially inner end; an ignition gap formed between the ground electrode and the center electrode; wherein the ground electrode has, at its radially inner end, and/or the bore has, at its radially outer end, an insertion aid.

### FIELD

The present invention relates to a spark plug.

### BACKGROUND INFORMATION

For some time, new spark plug concepts have increasingly been pursued in which the ignition gap is formed within the housing. In one of these concepts, the ground electrode is inserted in a bore in the housing wall and projects laterally from the housing wall into the internal space of the housing. German Patent Application No. DE 10 2017 221 517 A describes, for example, a prechamber spark plug in which the ground electrode is arranged in a bore in the housing wall and projects laterally into the internal space.

A ground electrode inserted laterally into the spark plug presents new challenges regarding correct orientation of the ground electrode with respect to the center electrode and adjustment of the ignition gap. In the case of a prechamber spark plug, the challenge results from the fact that the view of the electrodes and the ignition gap may be occluded by a cap arranged on the housing, making it more difficult to monitor the process of installing the ground electrode in the spark plug.

In the case of a spark plug with an open combustion-chamber-side end of the housing, the challenge of the occluded view of the electrodes and the ignition gap does not arise. Here, the challenge is that the ignition gap is formed at least partly within the housing, so that after placement of the ground electrode there is little space for post-processing of the electrodes to adjust the electrode spacing.

An object of the present invention is to provide a spark plug which allows reliably correct installation of the ground electrode, so that the need for expensive monitoring processes during the installation of the ground electrode and post-processing of the electrodes after the installation of the ground electrode is minimized.

### SUMMARY

The object may achieved by the spark plug according to the present invention.

A spark plug according to the present invention has a longitudinal axis X as well as a housing and an insulator arranged within the housing. The center electrode is arranged within the insulator. The spark plug comprises a rod-shaped ground electrode having a radially inner end and a radially outer end with respect to the longitudinal axis X of the spark plug. Furthermore, the spark plug has a bore in which the ground electrode is inserted, so that the spark plug has a laterally inserted ground electrode. The bore has a radially inner end and a radially outer end with respect to the longitudinal axis X of the spark plug. The ignition gap is formed between the ground electrode and the center electrode. The ground electrode has an insertion aid at its radially inner end. Additionally or alternatively, the bore has an insertion aid at its radially outer end.

According to an example embodiment of the present invention, the insertion aid on the ground electrode and/or on the bore simplifies the process of installing the ground electrode. This is true in particular when the ground electrode and the bore are sized to each other such that the ground electrode is secured in the bore by an interference fit. The insertion aid ensures that the ground electrode does not tilt during insertion into the bore, but rather remains straight, so that the ground electrode can be inserted into the bore with even pressure and even movement. This prevents the build-up of undesirable stresses between the ground electrode and the bore which can be slowly relieved after the ground electrode has been installed in the bore and which can lead to a position change of the ground electrode.

The radially inner end of the bore and the radially inner end of the ground electrode are spatially closer to the longitudinal axis X of the spark plug than the respective radially outer ends are.

Advantageous developments of the present invention are disclosed herein.

In an advantageous development of the present invention, the insertion aid on the ground electrode is a taper of the outer diameter of the ground electrode towards the longitudinal axis X of the spark plug. Additionally or alternatively, the insertion aid on the bore is a taper of the inner diameter of the bore towards the longitudinal axis X of the spark plug. The advantage of the insertion aid in the form of a taper of the diameter is that this can be easily accomplished during the production of the spark plug or its individual parts and the overall production is not made significantly longer or more complicated. The insertion aid or the taper may be implemented, for example, by a rounding of the edges of the ground electrode or of the walls delimiting the bore or by a chamfer on these edges.

In an advantageous variant of the spark plug according to the present invention, the insertion aid is a round. The round advantageously has a radius R of equal to or greater than 0.05 mm and equal to or less than 1 mm. This size has the result that the round is large enough to fulfill the function of the insertion aid and at the same time is not too large, so that the ground electrode is still reliably secured in the bore without changing its position over time.

In another advantageous variant of the spark plug according to the present invention, the insertion aid is a chamfer. The chamfer has a length L measured parallel to the longitudinal direction of the bore or ground electrode, which also corresponds to the insertion direction of the ground electrode. The length L of the chamfer is equal to or greater than 0.1 mm and equal to or less than 1 mm. This size has the result that the chamfer is large enough to fulfill the function of the insertion aid and at the same time is not too large, so that the ground electrode is still reliably secured in the bore without changing its position over time.

For the chamfer, it has also been determined that an angle a is advantageously equal to or greater than 5° and equal to or less than 45°. The angle a lies between the surface of the chamfer and the insertion direction of the ground electrode. In particular, it has proven to be advantageous if the angle a for a chamfer formed on the ground electrode is equal to or greater than 10° and equal to or less than 45°. If the chamfer is formed on the bore, then it has proven to be advantageous if the angle a is equal to or greater than 5° and equal to or less than 35°.

Example embodiments of the spark plug according to the present invention in which either the ground electrode or the bore has an insertion aid as well as an embodiment of the spark plug according to the present invention in which the ground electrode and the bore each have an insertion aid are advantageous. The desired technical effect is of course enhanced when both the ground electrode and the bore have an insertion aid. If the bore and the ground electrode have an insertion aid at their respective ends, the insertion aid may be implemented differently or similarly. For example, the bore may have a round and the ground electrode may have a chamfer, or vice versa, as an insertion aid. Alternatively, the bore and the ground electrode also may each have a chamfer of the same or different dimensions or may each have a round of the same or different dimensions.

Additionally, according to an example embodiment of the present invention, the spark plug may also have a second insertion aid on the ground electrode and/or on the bore. This second insertion aid is, for example, in the form of grooves on one or both of the respective mutually contacting contact surfaces of the ground electrode and of the bore. The grooves run parallel to the insertion direction of the ground electrode. The contact surface of the bore which contacts the ground electrode is formed by the walls which delimit the bore. The grooves serve as a guide during the insertion of the ground electrode into the bore and thus ensure that the ground electrode is inserted into the bore with even pressure and even speed. In addition, the deformation of the grooves can directly relieve possible stresses that developed during the insertion of the ground electrode. The grooves may be produced during the manufacture of the ground electrode, for example by extrusion, drawing or calibration of the external shape.

In an example embodiment of the spark plug according to the present invention, the ground electrode comprises a base body and an ignition element which forms the ignition surface. The ignition element is fixed to the base body and has a smaller diameter than the base body. The insertion aid is formed on the base body. Because the insertion aid is typically formed by removal of material and the ignition element is made of more expensive material than the base body, this embodiment prevents expensive material from being wasted by material removal during the forming of the insertion aid. The functionality of the insertion aid is maintained.

In an advantageous example embodiment of the present invention, the bore in which the ground electrode is inserted is formed in the housing.

In another advantageous example embodiment of the present invention, the spark plug has a cap which is fastened to the combustion-chamber-side end of the housing and the spark plug is a prechamber spark plug, wherein the bore in which the ground electrode is inserted is formed in the cap or in the housing.

In combination or alternatively, in further embodiments the ignition gap between the central electrode and the ground electrode is a radial ignition gap and/or the ignition gap is formed at least partly, in particular completely, within the internal space of the housing.

The ground electrode can be pressed and/or soldered or welded in the bore.

The housing typically has a longitudinal bore parallel to the longitudinal axis X of the spark plug, the housing thus having a housing wall and an internal space. The bore in which the ground electrode is inserted is formed in the housing wall, for example. The ignition gap is then formed at least partly, in particular completely, within the internal space of the housing.

### BRIEF DESCRIPTION OF THE DRAWINGS

FIG. 1 shows an example of a spark plug with a ground electrode inserted.

FIG. 2 shows a first example of the design of the bore and the ground electrode according to the present invention.

FIG. 3 shows a second example of the design of the bore and the ground electrode according to the present invention.

### DETAILED DESCRIPTION OF EXAMPLE EMBODIMENTS

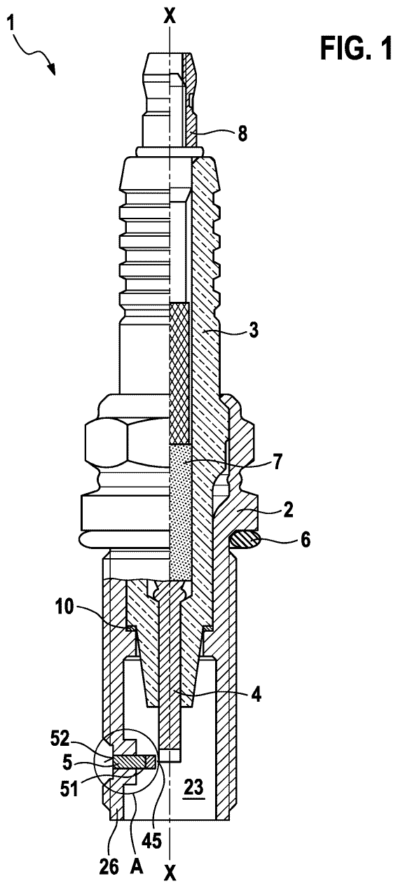

FIG. 1 shows a spark plug 1 in a semi-sectioned representation. The spark plug 1 has a longitudinal axis X which extends from the combustion-chamber-side end of the spark plug to the end of the spark plug 1 remote from the combustion chamber. The spark plug 1 has a housing 2 which has a longitudinal bore parallel to the longitudinal axis X of the spark plug 1, the housing 2 thus having a housing wall 26 and an internal space 23. The housing 2 typically has, on the outer side thereof, a thread by which the spark plug 1 can be screwed into a cylinder head. Typically, an outer seal 6 is arranged on the outer side of the housing 2, the outer seal sealing a transition between the housing 2 and the cylinder head.

The insulator 3 is arranged and fastened within the housing 2. The gap between the housing 2 and the insulator 3 is sealed by an inner seal 10. Proceeding from the end of the insulator remote from the combustion chamber, a terminal stud 8, a resistor element 7 and a center electrode 4 are arranged in the insulator 3 and are electrically contacted with each other. The center electrode 4 typically projects out of the combustion-chamber-side end of the insulator 3 and, in this example, into the internal space 23 of the housing 2.

In this example, the ground electrode 5 is inserted in a bore 20 formed in the housing wall 26. The ground electrode 5 is rod-shaped and has a radially inner end 51 and a radially outer end 52. The radially inner end 51 of the ground electrode 5 projects laterally into the internal space 23 of the housing. The radially inner end 51 of the ground electrode 5 forms the ignition gap 45 together with the center electrode 4. In this example, the two electrodes 4, 5 form a radial ignition gap 45. The ground electrode 5 and the center electrode 4 may also be arranged with respect to each other such that they form an axial ignition gap.

The center electrode 4 and/or the ground electrode 5 may each have a precious-metal-containing ignition element 54 at their ends delimiting the ignition gap 45. In the case of the ground electrode 5, the precious-metal-containing ignition element 54 is then arranged at the radially inner end 51 of the ground electrode 5.

In an alternative embodiment, a cap may be arranged on the combustion-chamber-side end face of the housing 2. The housing 2 and the cap together form a prechamber with a prechamber volume.

The bore 20 in which the ground electrode 5 is inserted can be formed in a housing wall 26 or in a cap wall.

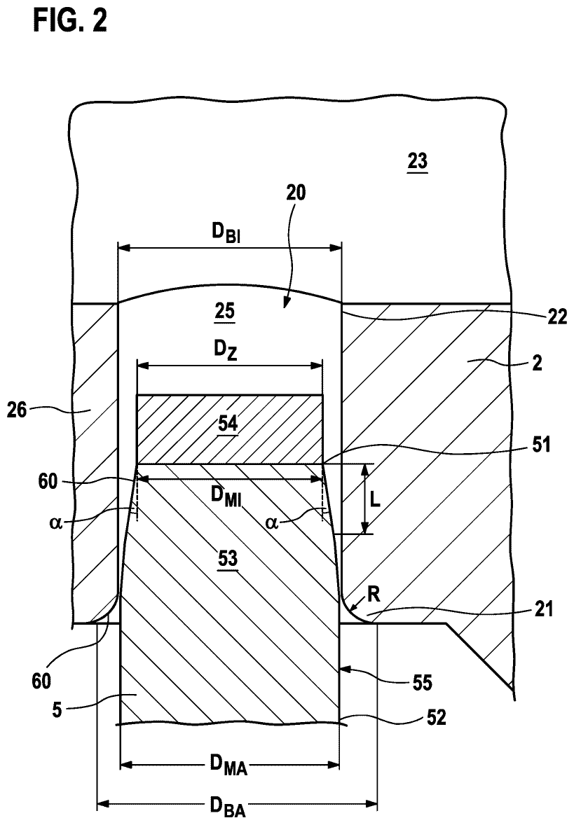

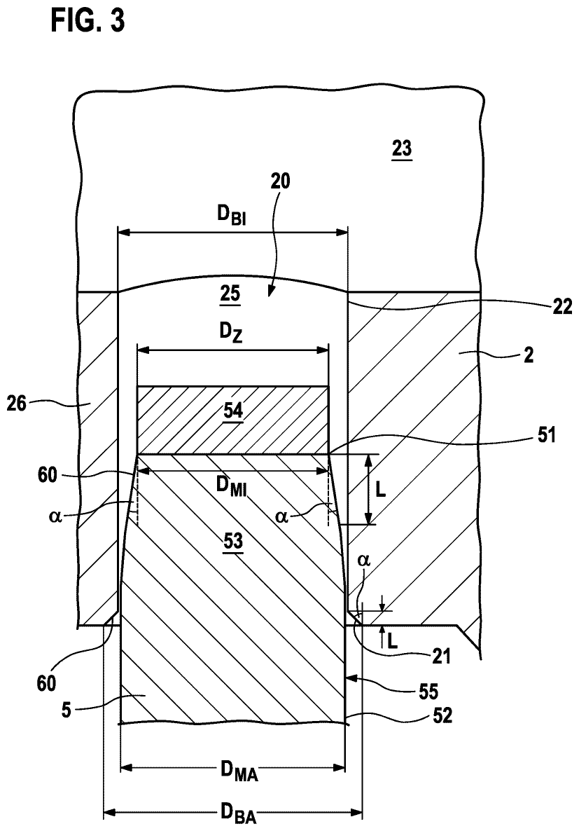

FIG. 2 and FIG. 3 each show an enlargement of the region marked with circle A in FIG. 1; in each case, the ground electrode 5 is not yet in its final position in the bore 20, but rather a snapshot of the insertion of the ground electrode 5 into the bore 20 is shown for clarity. FIG. 2 shows a first example and FIG. 3 shows a second example of the implementation of the insertion aid 60 on the bore 20 and on the ground electrode 5.

The following description of the figures applies to FIGS. 2 and 3, unless reference is explicitly made to a figure.

The wall 26 of the housing 2 or of the cap delimits the bore 20 laterally to its longitudinal extension. The bore 20 has a radially outer end 21 and a radially inner end 22. At its radially inner end 22, the bore 20 has a diameter D_{BI}. At its radially outer end 21, the bore 20 has a diameter DBA. The diameter D_{BI} of the bore 20 at its radially inner end 22 is smaller than the diameter DBA of the bore 20 at its radially outer end 21. This tapering of the diameter of the bore 20 towards the longitudinal axis X of the spark plug 1 results from the insertion aid 60 formed at the radially outer end 21 of the bore 20. In the example according to FIG. 2, the insertion aid 60 at the radially outer end 21 of the bore 20 is configured as a round. The round has a radius R from 0.05 to 1.0 mm. In the example according to FIG. 3, the insertion aid 60 at the radially outer end 21 of the bore 20 is configured as a chamfer. For example, the chamfer has a length L of 0.1 to 1 mm and an angle a of 5° to 35°.

In a development, the bore 20 can have, as a second insertion aid, grooves on the contact surface 25 which contacts the ground electrode 5. These grooves preferably extend parallel to the insertion direction of the ground electrode 5. For example, the grooves are formed over the entire length and/or along the entire circumference of the contact surface 25 of the bore 20.

The ground electrode 5 is rod-shaped and has a radially inner end 51 and a radially outer end 52. In these examples, the ground electrode 5 has a base body 53 and an ignition element 54 arranged on and fastened to the radially inner end 51 of the base body 53. The ignition element 54 has a diameter Dz. The base body 53 has a diameter Dy at the radially inner end 51 of the base body 53 and a diameter DMA at the radially outer end 51 of the base body 53. The following applies to the diameters:

$${D}_{Z} \leq {D}_{MI}$$

$${D}_{MI} < {D}_{MA}$$

This tapering of the diameter of the base body 53 towards the longitudinal axis X of the spark plug 1 results from the insertion aid 60 formed at the radially inner end 51 of the base body 53. In FIG. 2 and FIG. 3, the insertion aid 60 at the radially inner end 51 of the base body 53 is configured as a chamfer. For example, the chamfer has a length L of 0.1 to 1 mm and an angle a of 10° to 45°. In the examples, the possibility that the insertion aid 60 on the ground electrode 5 is implemented by a round is not shown.

If the ground electrode 5 does not have an ignition element 54, then the base body 53 is the ground electrode 5.

In a development, the ground electrode 5 or the base body 53 of the ground electrode 5 can have, as a second insertion aid, grooves on the contact surface 55 which contacts the bore 20. These grooves preferably extend parallel to the insertion direction of the ground electrode 5. For example, the grooves are formed over the entire length and/or along the entire circumference of the contact surface 55 of the ground electrode or its base body 53.

1-10. (canceled)

11. A spark plug having a longitudinal axis, comprising:
a housing;
an insulator arranged within the housing;
a center electrode arranged within the insulator;
a ground electrode, the ground electrode being rod-shaped and having a radially inner end and a radially outer end;
a bore in which the ground electrode is inserted, the bore having a radially outer end and a radially inner end; and
an ignition gap formed between the ground electrode and the center electrode;
wherein: (i) the ground electrode has, at its radially inner end, an insertion aid and/or (ii) the bore has, at its radially outer end, the insertion aid.

12. The spark plug according to claim 11, wherein the insertion aid is a taper of an outer diameter of the ground electrode or of an inner diameter of the bore towards the longitudinal axis the spark plug.

13. The spark plug according to claim 11, wherein the insertion aid is a round and the round has a radius of 0.05 to 1.0 mm.

14. The spark plug according to claim 11, wherein the insertion aid is a chamfer and the chamfer has a length of 0.1 to 1 mm measured parallel to an insertion direction of the ground electrode.

15. The spark plug according to claim 14, wherein the chamfer has an angle a equal to or greater than 5° and equal to or less than 45°, a being the angle between the insertion direction of the ground electrode and the chamfer.

16. The spark plug according to claim 11, wherein the bore and the ground electrode have the same or a different insertion aid formed at the radially outer end of the bore and the radially inner end of the ground electrode, and the insertion aid is a round or a chamfer.

17. The spark plug according to claim 11, wherein the ground electrode and/or the bore have, as second insertion aids, grooves on their respective mutually contacting contact surfaces, the grooves running parallel to the insertion direction of the ground electrode.

18. The spark plug according to claim 11, wherein the ground electrode includes a base body and an ignition element which forms the ignition surface, the ignition element being fastened to the base body and having a smaller diameter than the base body, and the insertion aid being formed on the base body.

19. The spark plug according to claim 11, wherein the bore in which the ground electrode is inserted is formed in the housing.

20. The spark plug according to claim 11, wherein the spark plug has a cap which is fastened to a combustion-chamber-side end of the housing and the spark plug is a prechamber spark plug, the bore in which the ground electrode is inserted being formed in the cap or in the housing.
